(19) United States
(12) Patent Application Publication
(10) Pub. No.: US 2024/0227513 A1
(43) Pub. Date: Jul. 11, 2024

(54) WINDOW ELEMENT FOR THE ACOUSTIC INSULATION OF A VEHICLE

(71) Applicant: SAINT-GOBAIN GLASS FRANCE, COURBEVOIE (FR)

(72) Inventors: Xuejuan XU, COMPIEGNE (FR); Fabien DALZIN, COMPIEGNE (FR)

(21) Appl. No.: 18/558,847

(22) PCT Filed: May 6, 2022
(86) PCT No.: PCT/FR2022/050870

§ 371 Date: Nov. 3, 2023

(30) Foreign Application Priority Data
May 6, 2021 (FR) FR2104800

(51) Int. Cl. B60J 1/20; B32B 17/10

(52) U.S. Cl. CPC B60J 1/2097; B32B 17/10036; B32B 2305/345; B32B 2307/102; B32B 2307/51

(57) ABSTRACT

A glazed element for a vehicle includes a laminated glazing, the laminated glazing including two glass sheets and a soundproofing layer made of a visco-elastic material and arranged between the two glass sheets, wherein the glazed element includes a device for measuring the temperature of the acoustic layer.

### FIELD OF THE INVENTION

The present invention relates to a glazed element comprising laminated glazing for a vehicle, and more particularly to laminated glazing having soundproofing properties.

### STATE OF THE ART

It is known to manufacture a windscreen of a vehicle using laminated glazing. The laminated glazing can comprise two glass sheets and an interlayer, for example an interlayer made of polyvinyl butyral (PVB), separating the two glass sheets. The PVB interlayer is ductile, so that cracks of one of the glass sheets are not transmitted to the other glass sheet.

However, such laminated glazing has soundproofing properties that are too low with respect to the acoustic comfort of the user of the vehicle.

In this regard, document FR 2 990 948 describes laminated glazing, wherein the interlayer comprises two outer layers of PVB, and a so-called “acoustic” inner layer, arranged between the two outer layers, the inner layer having vibro-acoustic damping properties greater than the vibro-acoustic damping properties of the two outer layers. In particular, a material of the inner layer has a loss factor tan δ greater than the loss factor of a material of outer layers. Thus, the laminated glazing described in document FR 2 990 948 makes it possible to increase the sound transmission loss through the laminated glazing for frequencies greater than 2000 hertz with respect to other known laminated glazings.

However, the sound transmission loss of such laminated glazing decreases when the ambient temperature decreases, especially when the ambient temperature is less than 10° C. Referring to FIG. 1, the curve (a) illustrates a sound transmission loss (STL) of known laminated glazing comprising an acoustic interlayer, at a temperature of 20° C., and the curve (b) illustrates a sound transmission loss of the same known laminated glazing comprising an acoustic interlayer, at a temperature of 13ºC.

### DISCLOSURE OF THE INVENTION

One aim of the invention is to propose a solution to prevent the sound transmission loss of laminated glazing from decreasing when the ambient temperature varies.

This aim is achieved in the context of the present invention by virtue of a glazed element for a vehicle, comprising laminated glazing, the laminated glazing comprising two glass sheets and a soundproofing layer made of a visco elastic material and arranged between the two glass sheets, the glazed element comprising a device for measuring the temperature of the acoustic layer.

The present invention is advantageously completed by the following features, taken individually or in any of their technically possible combinations:
the glazed element comprises a device for conditioning the temperature of the soundproofing layer,
the glazed element comprises a closed-loop feedback controller, the device for measuring the temperature of the soundproofing layer being capable of measuring a temperature of the soundproofing layer and of transmitting information of the temperature of the soundproofing layer to the controller, and the controller being able to transmit control information to the device for conditioning the temperature of the soundproofing layer,
the glazed element comprises a control unit configured to control a measurement of a temperature of the soundproofing layer by the device for measuring the temperature, to transmit the information of the temperature of the soundproofing layer to the controller, to determine a value representative of a difference between the temperature of the soundproofing layer and between a setpoint temperature, preferentially a predetermined optimal acoustic temperature, to control the determination of control information by the controller from the value representative of the difference, and to transmit the control information to the device for conditioning the temperature of the soundproofing layer,
the laminated glazing has a critical frequency f_{c}, the visco-elastic material has a maximal loss frequency fₚ for which a loss factor tan δ is maximal in a frequency range comprised between 50 Hz and 10 KHz for a predetermined temperature of the visco-elastic material, the predetermined optimal acoustic temperature being equal to a temperature for which the critical frequency f_{c} is equal to the maximal loss frequency fₚ,
the visco-elastic material has a maximum loss factor tan δ greater than 0.6 in a temperature range comprised between 10° C. and 60° C. and in a frequency range comprised between 50 Hz and 10 KHz, the material preferably having a value of the real part E′ of the Young's modulus that is less than 5.8·10⁷ N·cm⁻² in a temperature range comprised between 10° C. and 60° C. and in a frequency range comprised between 50 Hz and 10 KHz,
the laminated glazing comprises a first outer face and a fourth outer face opposite the first face, and the device for measuring the temperature of the acoustic layer comprises a first sensor configured to measure the temperature of the first face and a second sensor configured to measure the temperature of the fourth face.

Another aspect of the invention is a method for soundproofing a glazed element, the glazed element being a glazed element according to one embodiment of the invention, the glazed element further comprising a device for conditioning the temperature of the soundproofing layer and a closed-loop feedback controller, the device for measuring the temperature of the soundproofing layer being capable of measuring a temperature of the soundproofing layer and of transmitting information of the temperature of the soundproofing layer to the controller, the controller being capable of transmitting control information to the device for conditioning the temperature of the soundproofing layer,
the method comprising the steps of:
a) measuring a temperature of the soundproofing layer by the device for measuring the temperature,
b) transmitting the information of the temperature of the soundproofing layer to the controller,
c) determining a value representative of a difference between the temperature of the soundproofing layer and between a setpoint temperature, preferentially a predetermined optimal acoustic temperature,
d) determining control information by the controller from the value representative of the difference, and
e) transmitting the control information to the device for conditioning the temperature of the soundproofing layer.

Advantageously, the glazing has a critical frequency f_{c}, the visco-elastic material has a maximal loss frequency fₚ for which a loss factor tan δ is maximal in a frequency range comprised between 50 Hz and 10 KHz for a predetermined temperature of the visco-elastic material, the predetermined optimal acoustic temperature being equal to a temperature for which the critical frequency f_{c} is equal to the maximal loss frequency fₚ.

Advantageously, during step d), the control information is also determined from information associated with at least one feature selected from a hygrometry inside the vehicle, a temperature inside the vehicle, and information of the presence of mist on the laminated glazing.

### DESCRIPTION OF THE FIGURES

Other characteristics, purposes and advantages of the invention will become clear from the following description, which is purely illustrative and non-limiting, and which must be read in the context of the attached drawings in which:

FIG. 1 schematically illustrates a sound transmission loss of a known laminated glazing comprising a soundproofing layer at a temperature of 20° C., and a sound transmission loss of the same laminated glazing at a temperature of 20° C.,

FIG. 2 schematically illustrates a glazed element according to one embodiment of the invention,

FIG. 3 schematically illustrates the dependency on the temperature of the laminated glazing of the loss factor tan δ of the acoustic layer of a glazed element according to one embodiment of the invention,

FIG. 4 schematically illustrates a method according to one embodiment of the invention.

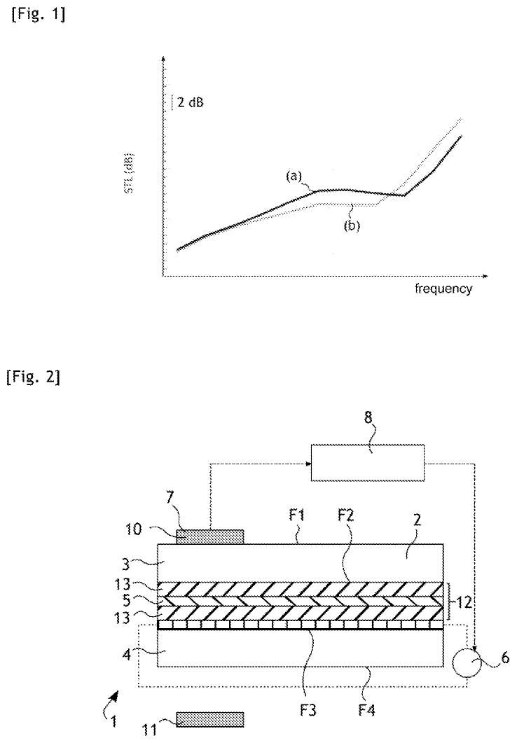

In all the figures, similar elements are marked with identical references.

### Definitions

“Critical frequency f_{c}” of laminated glazing means the frequency for which the bending phase velocity of the laminated glazing is equal to the phase velocity of an acoustic wave incident on the laminated glazing.

“Loss factor tan δ” of a material means, when the material has a complex Young's modulus E, the ratio between the imaginary part E′ of the Young's modulus of the material and the real part E of the Young's modulus of the material.

The loss factor tan δ of a material, also referred to as “n”, is defined by international standard ISO 18437-2:2005 (Mechanical vibration and shock—Characterization of the dynamic mechanical properties of visco-elastic materials—Part 2: Resonance method, part 3.2).

A dynamic characterization of a material is carried out on a visco-analyzer of the Metravib visco-analyzer type, under the following measurement conditions, to determine the real part E′ and the imaginary part E″ of the Young's modulus. A sinusoidal load is applied to the material. A measurement sample made of the material to be measured consists of two rectangular parallelepipeds, each parallelepiped having a thickness of 3.31 mm, a width of 10.38 mm and a height of 6.44 mm. Each parallelepiped made of the material is also referred to as a shear “test specimen”. The excitation is implemented with a dynamic amplitude of 6.5 μm around the rest position, covering the frequency range comprised between 5 Hz and 700 Hz, and covering a temperature range comprised between −20° ° C. and +60° C.

The visco-analyzer makes it possible to subject each test specimen (each sample) to deformations under precise temperature and frequency conditions, and to measure the displacements of the test specimen, the forces applied to the test specimen and their phase shift, which makes it possible to measure rheological quantities characterizing the material of the test specimen.

The use of measurements makes it possible especially to calculate the Young's modulus E of the material, and particularly the real part E of the Young's modulus and the imaginary part E″ of the Young's modulus of the material, and thus to calculate the tangent of the loss angle (or loss factor) tan δ.

“Laminated glazing” means a glazed assembly comprising at least two glass sheets and an interlayer film made of plastic material, preferentially visco-elastic, separating the two glass sheets. The interlayer film made of plastic material can comprise one or more layers of a visco-elastic polymer such as polyvinyl butyral (PVB) or an ethylene-vinyl acetate copolymer (EVA). The interlayer film is preferably made of standard PVB and/or of acoustic PVB (such as single-layer or tri-layer acoustic PVB). The acoustic PVB can comprise three layers: two outer layers of standard PVB and an inner layer that is less rigid than the outer layers. The inner layer can be made of a material comprising a proportion of plasticizer greater than the proportion of plasticizer of the material of the two outer layers. The inner layer can have a loss factor greater than the loss factor of each of the two outer layers. The inner layer can, for example, comprise PVB.

### DETAILED DESCRIPTION OF THE INVENTION

Referring to FIG. 2, a glazed element 1 for a vehicle comprises laminated glazing 2. The laminated glazing 2 comprises a first glass sheet 3, a second glass sheet 4 and a soundproofing layer 5 made of a visco-elastic material. The soundproofing layer 5 is arranged between the first glass sheet 3 and the second glass sheet 4. The glazed element 1 comprises a device 6 for measuring the temperature of the acoustic layer 5.

The first glass sheet 3 comprises a first face F1, the first face F1 being an outer face of the laminated glazing 2. The first glass sheet 3 comprises a second face F2 arranged on the side of the soundproofing layer 5 with respect to the first glass sheet 3, and opposite the first face F1 with respect to the first glass sheet 3. The second glass sheet 4 comprises a third face F3 arranged on the side of the soundproofing layer 5 with respect to the second glass sheet 3. The second glass sheet 4 comprises a fourth face F4, the fourth face F4 being an outer face of the laminated glazing 2, and being opposite the third face F3 with respect to the second glass sheet 4.

### Interlayer 12

The laminated glazing 2 can comprise an interlayer 12, the interlayer 12 comprising the soundproofing layer 5. The interlayer 12 can comprise two plastic outer layers 13, for example made of PVB, the soundproofing layer 5 being arranged between the two plastic outer layers 13.

The soundproofing layer 5 can be made of a visco-elastic material has a maximum loss factor tan δ greater than 0.6 in a temperature range comprised between 10° C. and 60° C. and in a frequency range comprised between 50 Hz and 10 KHz. Preferably, the material has a value of the real part E′ of the Young's modulus that is less than 5.8·10⁷ N·cm⁻² in a temperature range comprised between 10° C. and 60° C. and in a frequency range comprised between 50 Hz and 10 KHz.

The soundproofing layer 5 can be for example made from a PVB resin having a plasticizer content greater than 50% by weight, and preferentially greater than 60%. The plastic outer layers 12 can be for example made from a PVB resin having a plasticizer content by weight of less than 25%, and preferentially comprised between 18% and 22%.

### Device 6 for Measuring the Temperature of the Acoustic Layer 5

The device 6 for measuring the temperature is configured to measure the temperature of the acoustic layer 5.

The device 6 for measuring the temperature can comprise a sensor arranged directly in contact with the acoustic layer 5, so as to directly measure the temperature of the acoustic layer 5. The device 6 for measuring the temperature can comprise a film or a wire made of an electrically conductive material, arranged between the acoustic layer 5 and the first glass sheet 3 or the second glass sheet 4, and preferably arranged on the second face F2. Measuring the conductivity of the film or wire of electrically conductive material makes it possible to measure the temperature of the film or wire of conductive material.

As a variant or additionally, the device 6 for measuring the temperature of the acoustic layer 5 can comprise a first sensor 10 configured to measure the temperature of the first face F1 and a second sensor 11 configured to measure the temperature of the fourth face F4. In this configuration, the glazed element 1 can comprise a control unit configured to determine the temperature of the acoustic layer 5 from information of the temperature of the first face F1 transmitted by the first sensor 10 to the control unit, and information of the temperature of the fourth face F4 transmitted by the second sensor 11 to the control unit. Preferably, the control unit determines the temperature of the acoustic layer 5 from information transmitted by the first sensor 10 and by the second sensor 11 by a calculation implementing a heat conduction model in the laminated glazing 2. The heat conduction model can be representative of at least one feature selected from the temperature of the first face F1, the thermal resistance of the first glass sheet 3, the thermal resistance of the soundproofing layer 5, the thermal resistance of the interlayer 12, the thermal resistance of the second glass sheet, and the temperature of the fourth face F4. The heat conduction model can also be representative of the heat transfer through the layers that form the laminated glazing.

The first sensor 10 and/or the second sensor 11 can be selected at least from a thermocouple, an infrared sensor and a temperature sensor internal and/or external to the passenger compartment of the vehicle. The first sensor 10 and/or the second sensor 11 can comprise a film or a wire made of an electrically conductive material, arranged between the first glass sheet 3 and the second glass sheet 4, or on the first face F1, or on the second face F4. Measuring the conductivity of the film or wire of electrically conductive material makes it possible to measure the temperature of the film or wire of conductive material.

The first sensor 10 and/or the second sensor 11 can be arranged on the first face F1 and/or on the second face F4. The first sensor 10 and/or the second sensor 11 can be arranged in a housing formed by the rearview mirror, the rearview mirror being fixedly mounted on the fourth face F4.

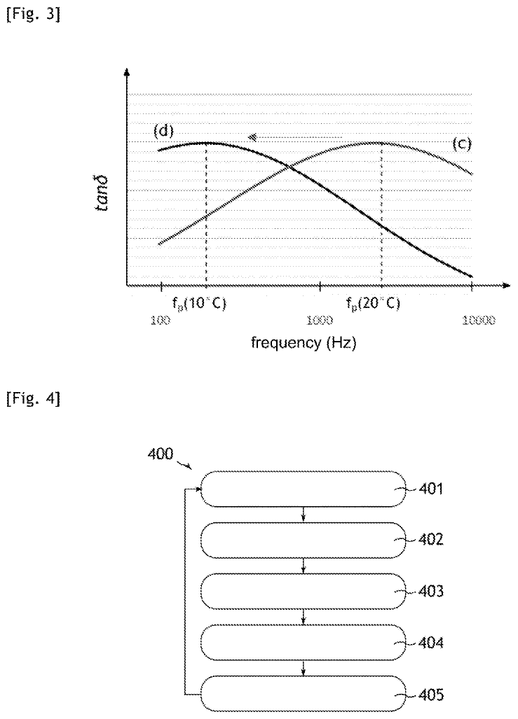

Referring to FIG. 3, the inventors have characterized the dependency of the loss factor tan δ of the acoustic layer 5 on the temperature of the laminated glazing 2. The curve (c) illustrates the evolution of the loss factor tan δ depending on the frequency of an acoustic wave incident on the laminated glazing 2, for a temperature equal to 20° C. The curve (d) illustrates the evolution of the loss factor tan δ depending on the frequency of an acoustic wave incident on the laminated glazing for a temperature equal to 10° C.

The curve (c) and the curve (d) each display a maximal loss frequency fₚ for which the loss factor tan δ is maximal in a frequency range comprised between 50 Hz and 10 KHz, for a predetermined temperature of the visco-elastic material. The soundproofing of the laminated glazing 2 is maximal when the frequency fₚ is equal to the critical frequency f_{c} of the laminated glazing 2. Therefore, during a temperature variation, a difference between the frequency fₚ and the critical frequency f_{c} can increase. Thus, the glazed element 1 comprising a device 6 for measuring the temperature of the acoustic layer 5 makes it possible to obtain information on the frequency fₚ, with a view to reducing the difference between the frequency fₚ and the frequency f_{c} of the laminated glazing 2.

### Device 7 for Conditioning the Temperature of the Soundproofing Layer 5

Referring to FIG. 2, the glazed element 1 can comprise a device 7 for conditioning the temperature of the soundproofing layer 5. The device 7 for conditioning the temperature can be a layer and/or a wire made of an electrically conductive material. The conditioning of the temperature can be carried out by applying an electric potential to the terminals of the layer or of the wire by Joule effect. The layer and/or the wire can be arranged between the second face F2 and the soundproofing layer 5, and/or between the soundproofing layer 5 and the third face F3.

The device 7 for conditioning the temperature can comprise a device for conditioning the temperature of the passenger compartment of the vehicle. The device 7 for conditioning the temperature can comprise the heating, ventilation and air-conditioning (HVAC) system of the vehicle.

### Controller 8

Referring to FIG. 2, the glazed element 1 can comprise a closed-loop feedback controller 8. Preferably, the controller 8 is a proportional-integral-derivative (PID) controller. The device 6 for measuring the temperature of the soundproofing layer 5 can be capable of measuring a temperature of the soundproofing layer 5 and of transmitting information of the temperature of the soundproofing layer 5 to the controller 8. The controller 8 can be capable of transmitting control information to the device 7 for conditioning the temperature of the soundproofing layer 5. Thus, it is possible to condition the temperature of the soundproofing layer 5 to a setpoint temperature Tₛ, so that the frequency f_{c} is closer to the critical frequency f_{c}, preferably equal to the critical frequency f_{c}, of the laminated glazing 2, than in the absence of temperature conditioning. It is then possible to improve the soundproofing performance of the laminated glazing 2.

The control unit of the glazed element 1 can be configured to control a measurement of a temperature of the soundproofing layer 5 by the device 6 for measuring the temperature, and to transmit the temperature information from the soundproofing layer 5 to the controller 8.

The control unit of the glazed element 1 can be configured to determine a value representative of a difference between the temperature of the soundproofing layer 5 and between a setpoint temperature Tₛ, preferentially a predetermined optimal acoustic temperature Tₒₚₜ.

The control unit of the glazed element 1 can be configured to control the determination of control information by the controller 8 from the value representative of a difference determined previously, and to transmit the control information to the device 7 for conditioning the temperature of the soundproofing layer 5. Thus, it is possible to maintain the temperature of the soundproofing layer 5 in a predetermined temperature range comprising the setpoint temperature Tₛ.

The predetermined optimal acoustic temperature Tₒₚₜ is equal to a temperature for which the critical frequency f_{c} is equal to the maximal loss frequency fₚ. Preferably, the setpoint temperature Tₛ is comprised in a temperature range comprised between (Tₒₚₜ−4° C.) and)(Tₒₚₜ+4° ° C., especially in a temperature range comprised between (Tₒₚₜ−2° C.) and (Tₒₚₜ+2° C.) and more preferentially, the setpoint temperature Tₛ is equal to the optimal temperature Tₒₚₜ.

### Method 400 for Soundproofing a Glazed Element 1

Referring to FIG. 4, another aspect of the invention is a method 400 for soundproofing a glazed element 1.

The method 400 comprises a first step 401 of measuring a temperature of the soundproofing layer by the device 6 for measuring the temperature.

The method 400 comprises a second step 402 of transmitting information of the temperature of the soundproofing layer 5 to the controller 8.

The method 400 comprises a third step 403 of determining a value representative of a difference between the temperature of the soundproofing layer 5 and between the setpoint temperature Tₛ, preferentially the predetermined optimal acoustic temperature Tₒₚₜ.

The method 400 comprises a fourth step 404 of determining control information by the controller 8 from the value representative of the difference.

The method 400 comprises a fifth step 405 of transmitting control information to the device 7 for conditioning the temperature of the soundproofing layer 5.

Thus, it is possible to increase the soundproofing properties of the glazed element 1, and particularly of the laminated glazing 2, by reducing the difference between the maximal loss frequency fₚ of the soundproofing layer 5 and between the critical frequency f_{c} of the laminated glazing 2.

### Improving the Acoustic Performance of the Glazed Element 1 Upon the Appearance of Mist on the Laminated Glazing 2

In certain conditions of use of the vehicle, it is possible for the temperature Tₒₚₜ, for which the maximal loss frequency fₚ of the soundproofing layer 5 is equal to the critical frequency f_{c} of the laminated glazing 2, to be less than the dewpoint temperature on the fourth face F4. Preferably, the control information is also determined from information associated with at least one feature selected from a hygrometry inside the vehicle, a temperature inside the vehicle, a temperature of the fourth face F4 and information of the presence of mist on the laminated glazing 2.

Thus, it is possible to increase the soundproofing properties of the glazed element 1 while preventing the formation of mist on the fourth face of the laminated glazing 2. Preferably, when the dewpoint temperature is greater than the optimal temperature Tₒₚₜ, the setpoint temperature Tₛ can be greater than or equal to the dewpoint temperature.

When the dewpoint temperature on the fourth face F4 is greater than the optimal temperature Tₒₚₜ, it is possible to implement a method for suppressing the mist on the fourth face F4. The method for suppressing the mist can comprise a step of conditioning the temperature and/or of conditioning the hygrometry on the fourth face F4 so that the dewpoint temperature on the fourth face F4 is less than the optimal temperature Tₒₚₜ. The method for suppressing the mist can comprise a step of conditioning the temperature and/or of conditioning the hygrometry in the passenger compartment of the vehicle so that the dewpoint temperature on the fourth face F4 is less than the optimal temperature Tₒₚₜ.

1. A glazed element for a vehicle comprising a laminated glazing, the laminated glazing comprising two glass sheets and a soundproofing layer made of a visco-elastic material and arranged between the two glass sheets, wherein the glazed element comprises a device for measuring a temperature of the soundproofing layer.

2. The glazed element according to claim 1, comprising a device for conditioning the temperature of the soundproofing layer.

3. The glazed element according to claim 1, comprising a closed-loop feedback controller, the device for measuring the temperature of the soundproofing layer being capable of measuring a temperature of the soundproofing layer and of transmitting information of the temperature of the soundproofing layer to the closed-loop feedback controller, the closed-loop feedback controller being capable of transmitting control information to the device for conditioning the temperature of the soundproofing layer.

4. The glazed element according to claim 3, comprising a control unit configured to:
control a measurement of the temperature of the soundproofing layer by the device for measuring the temperature,
transmit the information of the temperature of the soundproofing layer to the controller,
determine a value representative of a difference between the temperature of the soundproofing layer and between a setpoint temperature,
control the determination of control information by the controller from the value representative of the difference, and
transmit the control information to the device for conditioning the temperature of the soundproofing layer.

5. The glazed element according to claim 4, wherein the laminated glazing has a critical frequency f_{c}, the visco-elastic material has a maximal loss frequency fₚ for which a loss factor tan δ is maximal in a frequency range comprised between 50 Hz and 10 kHz for a predetermined temperature of the visco-elastic material, the predetermined optimal acoustic temperature being equal to a temperature for which the critical frequency f_{c} is equal to the maximal loss frequency fₚ.

6. The glazed element according to claim 1, wherein the visco-elastic material has a maximum loss factor tan δ greater than 0.6 in a temperature range comprised between 10° C. and 60° C. and in a frequency range comprised between 50 Hz and 10 kHz.

7. The glazed element according to claim 1, wherein the laminated glazing comprises an outer first face and an outer fourth face opposite the first face, and wherein the device for measuring the temperature of the acoustic layer comprises a first sensor configured to measure the temperature of the first face and a second sensor configured to measure the temperature of the fourth face.

8. A method for soundproofing a glazed element, the glazed element being a glazed element according to claim 1, the glazed element comprising a device for conditioning the temperature of the soundproofing layer and a closed-loop feedback controller, the device for measuring the temperature of the soundproofing layer being capable of measuring a temperature of the soundproofing layer and of transmitting information of the temperature of the soundproofing layer to the controller, the controller being capable of transmitting control information to the device for conditioning the temperature of the soundproofing layer, the method comprising:
a) measuring a temperature of the soundproofing layer by the device for measuring the temperature,
b) transmitting the information of the temperature of the soundproofing layer to the controller,
c) determining a value representative of a difference between the temperature of the soundproofing layer and between a setpoint temperature,
d) determining control information by the controller from the value representative of the difference, and
e) transmitting the control information to the device for conditioning the temperature of the soundproofing layer.

9. The method according to claim 8, wherein the glazing has a critical frequency f_{c}, the visco-elastic material has a maximal loss frequency fₚ for which a loss factor tan δ is maximal in a frequency range comprised between 50 Hz and 10 kHz for a predetermined temperature of the visco-elastic material, the predetermined optimal acoustic temperature being equal to a temperature for which the critical frequency f_{c} is equal to the maximal loss frequency fₚ.

10. The method according to claim 8, wherein, during step d), the control information is also determined from information associated with at least one feature selected from a hygrometry inside the vehicle, a temperature inside the vehicle, and information of a presence of mist on the laminated glazing.

11. The glazed element according to claim 3, wherein the setpoint temperature is a predetermined optimal acoustic temperature.

12. The glazed element according to claim 6, wherein the visco-elastic material has a value of the real part E′ of the Young's modulus that is less than 5.8·10⁷ N·cm⁻² in a temperature range comprised between 10° ° C. and 60° ° C. and in a frequency range comprised between 50 Hz and 10 KHz.

13. The method according to claim 8, wherein the setpoint temperature is a predetermined optimal acoustic temperature.
